(19) United States
(12) Patent Application Publication
(10) Pub. No.: US 2018/0319075 A1
(43) Pub. Date: Nov. 8, 2018

(54) IMPRINT APPARATUS AND ARTICLE MANUFACTURING METHOD

(71) Applicant: CANON KABUSHIKI KAISHA, Tokyo (JP)

(72) Inventor: Tosiya Asano, Utsunomiya-shi (JP)

(21) Appl. No.: 15/970,269

(22) Filed: May 3, 2018

(30) Foreign Application Priority Data
May 8, 2017 (JP) 2017-092565

(51) Int. Cl. B29C 59/02; B29C 59/00

(52) U.S. Cl. CPC B29C 59/02; B29C 59/002

(57) ABSTRACT

An imprint apparatus performs an imprint process of forming a pattern on a substrate by bringing a mold into contact with an imprint material on the substrate and curing the imprint material. The apparatus includes a detector configured to detect an arrangement relationship between the substrate and the mold, and an adjuster configured to adjust the arrangement relationship based on an output from the detector. The adjuster adjusts the arrangement relationship in a state in which a vibration is applied to an imprint material between the substrate and the mold, and then further adjusts the arrangement relationship in a state in which the vibration is not applied to the imprint material between the substrate and the mold.

### BACKGROUND OF THE INVENTION

### Field of the Invention

The present invention relates to an imprint apparatus and an article manufacturing method.

### Description of the Related Art

In an imprint apparatus, an imprint material is cured in a state in which a mold is brought into contact with an imprint material on shot region of a substrate, thereby forming a pattern made of the cured imprint material on the substrate. In the imprint apparatus, final alignment between the mold and the shot region of the substrate can be performed in a state in which the mold is in contact with the imprint material on the shot region. This alignment can be performed by adjusting the relative positions of the substrate and the mold while detecting the relative positions of the shot region and the mold by using an alignment mark provided in the shot region and an alignment mark provided in the mold. Such alignment is called dye-by-dye alignment.

An interval between the substrate and the mold in the state in which the mold is in contact with the imprint material on the shot region can be, for example, 1 μm or less. The imprint material shows viscoelasticity in the state in which the mold is in contact with the imprint material on the shot region. Viscoelasticity is a property obtained by combining viscosity and elasticity. If the relative positions of the substrate and the mold are changed in the state in which the mold is in contact with the imprint material on the shot region, an extremely large force acts between the substrate and the mold due to the viscoelasticity of the imprint material. This force may deform the pattern of the mold in addition to making it difficult to perform accurate alignment between the shot region and the mold.

Japanese Patent Laid-Open No. 2015-149315 has described an imprint apparatus that performs alignment between a substrate and a mold while applying a high-frequency vibration to an imprint material (resin) in order to reduce an influence by the viscoelasticity of the imprint material. In the imprint apparatus described in Japanese Patent Laid-Open No. 2015-149315, a vibration is stopped after completion of the alignment (paragraph 0019).

If a vibration is applied to the imprint material even after the completion of the alignment, however, the relative positions of the substrate and the mold may be changed by the vibration, possibly making an alignment error larger.

### SUMMARY OF THE INVENTION

The present invention provides a technique advantageous in reducing an alignment error while reducing deformation in pattern of a mold.

One of aspects of the present invention provides an imprint apparatus that performs an imprint process of forming a pattern on a substrate by bringing a mold into contact with an imprint material on the substrate and curing the imprint material, the apparatus comprising: a detector configured to detect an arrangement relationship between the substrate and the mold; and an adjuster configured to adjust the arrangement relationship based on an output from the detector, wherein the adjuster adjusts the arrangement relationship in a state in which a vibration is applied to an imprint material between the substrate and the mold, and then further adjusts the arrangement relationship in a state in which the vibration is not applied to the imprint material between the substrate and the mold.

Further features of the present invention will become apparent from the following description of exemplary embodiments with reference to the attached drawings.

### BRIEF DESCRIPTION OF THE DRAWINGS

FIG. 1 is a schematic view showing the arrangement of an imprint apparatus according to one embodiment of the present invention;

FIG. 2 is a block diagram showing an example of the arrangement of an adjuster incorporated into the imprint apparatus;

FIG. 3 is a flowchart exemplifying the operation of the imprint apparatus;

FIG. 4 is a flowchart exemplifying the operation of the imprint apparatus;

FIG. 5 is a graph exemplifying a vibration component generated by a vibration component generator or a vibration component given to the imprint material;

FIG. 6 is a schematic view showing the arrangement of an imprint apparatus according to the other embodiment of the present invention; and

FIGS. 7A to 7F show views of an article manufacturing method.

### DESCRIPTION OF THE EMBODIMENTS

The present invention will be described below with reference to the accompanying drawings by way of exemplary embodiments.

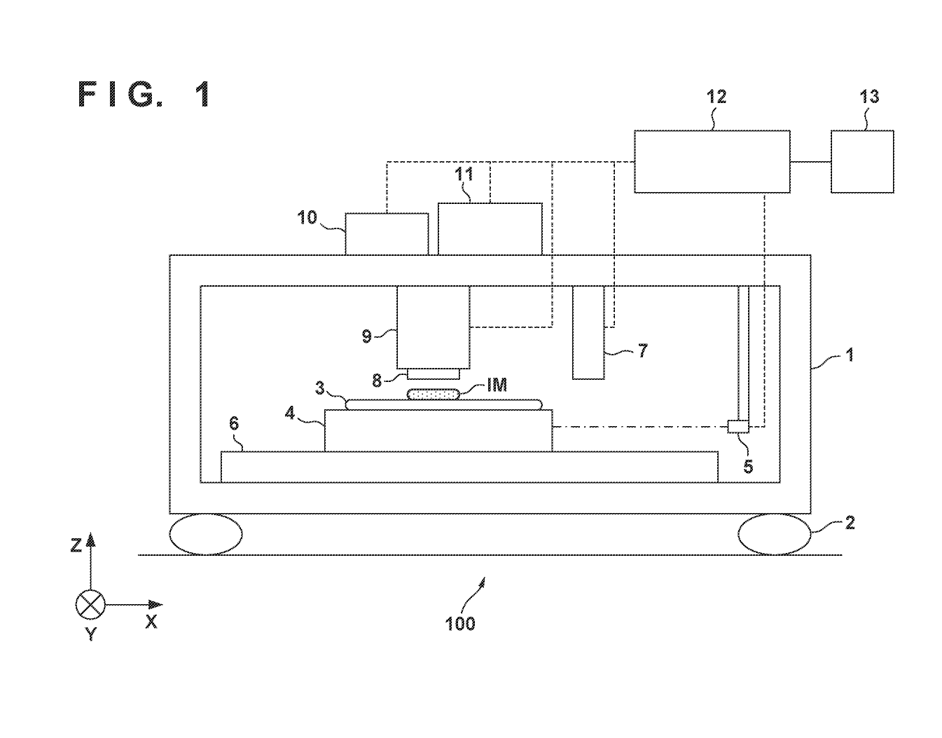

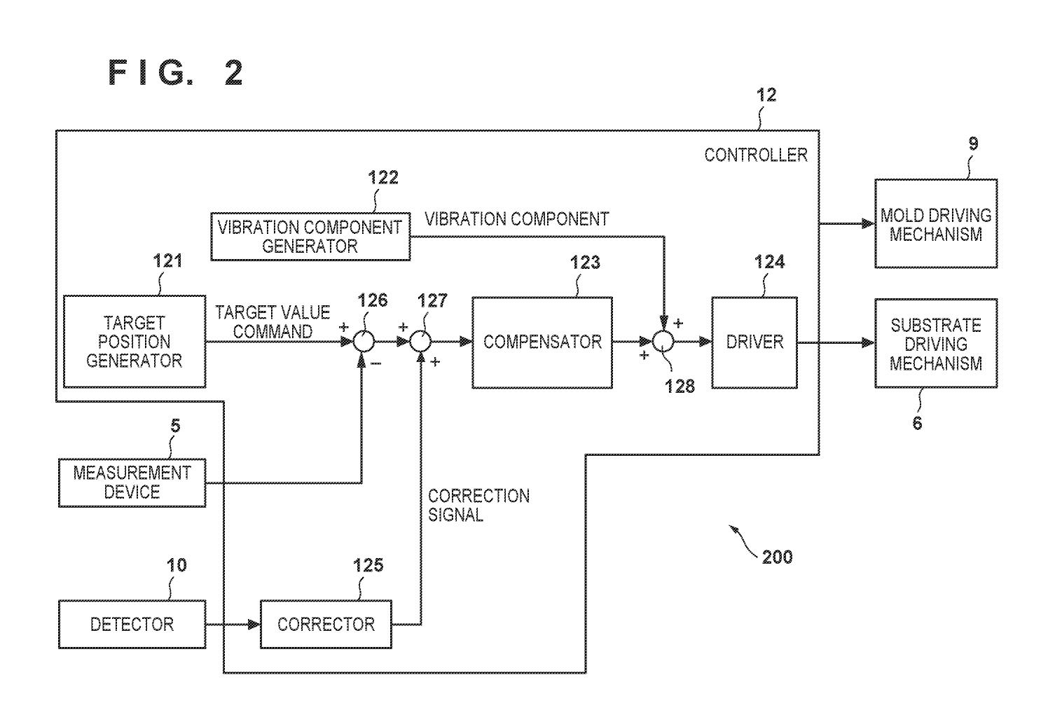

FIG. 1 schematically shows the arrangement of an imprint apparatus 100 according to one embodiment of the present invention. FIG. 2 shows an example of the arrangement of an adjuster 200 incorporated into the imprint apparatus 100. The adjuster 200 adjusts the arrangement relationship between a mold 8 and a shot region of a substrate 3. The imprint apparatus 100 performs an imprint process of forming a pattern on the shot region of the substrate 3 by bringing the mold 8 into contact with an imprint material IM on the shot region of the substrate 3 and curing the imprint material IM. The substrate 3 includes at least one shot region, and the shot region includes an alignment mark.

A curable composition (may also be referred to as an uncured resin) which is cured by receiving curing energy is used for the imprint material. An electromagnetic wave, heat, or the like can be used as the curing energy. For example, light such as infrared light, visible rays, ultraviolet light, or the like whose wavelength is selected from a range of 10 nm (inclusive) to 1 mm (inclusive) can be used as the electromagnetic wave. The curable composition can be a composition that is cured by light irradiation or application of heat. Out of these, a photo-curable composition that is cured by light irradiation contains at least a polymerizable compound and a photopolymerization initiator, and may further contain a non-polymerizable compound or solvent as needed. The non-polymerizable compound is at least a material selected from the group consisting of a sensitizer, a hydrogen donor, an internal mold release agent, a surfactant, an antioxidant, a polymer component, and the like. The imprint material can be arranged on a substrate in a droplet-like shape, or an island-like shape or a film-like shape formed by a plurality of droplets connected to each other. The viscosity (viscosity at 25° C.) of the imprint material can be set at, for example, 1 mPa·s (inclusive) to 100 mPa·s (inclusive). For example, glass, ceramics, a metal, a semiconductor, a resin, or the like can be used as a material of the substrate. A member made of a material different from that for the substrate may be provided on the surface of the substrate, as needed. For example, a silicon wafer, a compound semiconductor wafer, silica glass, or the like is used as the substrate.

In this specification and the accompanying drawings, directions are shown in an X-Y-Z coordinate system in which a direction parallel to the surface of the substrate 3 forms an X-Y plane. Let an X direction, a Y direction, and a Z direction be the directions parallel to an X-axis, a Y-axis, and a Z-axis, respectively, in the X-Y-Z coordinate system. Let OX, e, and OZ, respectively, be rotation about the X-axis, rotation about the Y-axis, and rotation about the Z-axis. Control or driving with regard to the X-axis, the Y-axis, and the Z-axis means control or driving with regard to the direction parallel to the X-axis, the direction parallel to the Y-axis, and the direction parallel to the Z-axis, respectively. Further, control or driving with regard to a θX-axis, a θY-axis, and a θZ-axis means control or driving with regard to rotation about an axis parallel to the X-axis, rotation about an axis parallel to the Y-axis, and rotation about an axis parallel to the Z-axis, respectively. A position is information that can be specified based on X-axis, Y-axis, and Z-axis coordinates. An attitude is information that can be specified by values on the θX-axis, the θY-axis, and the θZ-axis. Alignment means controlling the position and/or attitude. Alignment means, for example, controlling the positions with regard to the X-axis and the Y-axis, and the attitude with regard to the θZ-axis, and more specifically, reducing an overlay error between the mold and the shot region of the substrate. Alignment can include the control of the position and/or attitude of at least one of the substrate and the mold. The relative arrangement relationship between the mold and the substrate (or the shot region of the substrate) can include at least one of the relative positions of the mold and the substrate (or the shot region of the substrate), and the relative rotations of the mold and the substrate (or the shot region of the substrate).

The imprint apparatus 100 can include a substrate holder 4 that holds the substrate 3, a substrate driving mechanism 6 that drives the substrate 3 by driving the substrate holder 4, and a mold driving mechanism 9 that holds and drives the mold 8. The substrate driving mechanism 6 and the mold driving mechanism 9 are driving mechanisms that drive at least one of the substrate 3 and the mold 8 so as to adjust the relative arrangement relationship between the substrate 3 and the mold 8, and partially form the adjuster 200. Adjustment of the arrangement relationship between the substrate 3 and the mold 8 by the adjuster 200 includes contact of the mold 8 with respect to the imprint material on the substrate 3 and driving in order to separate the mold 8 from a cured imprint material (pattern of a cured product).

The substrate driving mechanism 6 can be configured to drive the substrate 3 with respect to a plurality of axes (for example, three axes of the X-axis, the Y-axis, and the θZ-axis, preferably six axes of the X-axis, the Y-axis, the Z-axis, the θX-axis, the θY-axis, and the θZ-axis). The mold driving mechanism 9 can be configured to drive the mold 8 with respect to a plurality of axes (for example, three axes of the Z-axis, the θX-axis, and the θY-axis, preferably six axes of the X-axis, the Y-axis, the Z-axis, the θX-axis, the θY-axis, and the θZ-axis).

The imprint apparatus 100 can include a measurement device 5 that measures the position of the substrate holder 4, and a detector 10 that detects the arrangement relationship between the mold 8 and the substrate 3 (shot region thereof). The measurement device 5 can include, for example, at least one of a laser interferometer and an encoder. The detector 10 detects the arrangement relationship between the mold 8 and shot region of the substrate 3 by using an alignment mark provided in the shot region and an alignment mark provided in the mold 8. The detector 10 can obtain the arrangement relationship as, for example, a shift amount between the shot region and the mold 8 with regard to the X-axis, the Y-axis, and the θZ-axis.

In addition, the imprint apparatus 100 can include a curing device 11 that cures the imprint material IM by irradiating the imprint material IM with energy that cures the imprint material IM. The imprint apparatus 100 can also include a dispenser 7 that arranges the imprint material IM on the substrate 3. The dispenser 7 can be configured to arrange imprint materials successively with respect to at least one shot region of the substrate 3. However, the dispenser 7 may be provided outside the imprint apparatus 100.

A support structure 1 can support the substrate driving mechanism 6, the mold driving mechanism 9, the measurement device 5, the detector 10, the curing device 11, and the dispenser 7. An anti-vibration mechanism 2 such as an air spring can support the support structure 1. The imprint apparatus 100 can further include a controller 12 that controls the substrate driving mechanism 6, the mold driving mechanism 9, the measurement device 5, the detector 10, the curing device 11, and the dispenser 7.

As exemplified in FIG. 2, the adjuster 200 can be formed by, for example, the controller 12, the measurement device 5, the detector 10, the substrate driving mechanism 6, and the mold driving mechanism 9. In this example, alignment with regard to the X-axis, the Y-axis, and the θZ-axis is performed by using the substrate driving mechanism 6. However, such alignment may be performed by the mold driving mechanism 9 or by both of the substrate driving mechanism 6 and the mold driving mechanism 9.

The controller 12 can include a target position generator 121, a vibration component generator 122, a compensator 123, a driver group 124, a corrector 125, a subtracter 126, an adder 127, and an adder 128. The target position generator 121 generates target value commands (target values with regard to the X-axis, the Y-axis, the θZ-axis) for driving the substrate 3 such that a shot region to undergo an imprint process out of a plurality of shot regions of the substrate 3 is arranged below the mold 8. The shot region to undergo the imprint process will simply be referred to as a shot region hereinafter. The subtracter 126 generates a deviation signal by subtracting values (measurement values with regard to the X-axis, the Y-axis, and the θZ-axis) of the substrate holder 4 (substrate 3) obtained by the measurement device 5 from the target value commands from the target position generator 121. The corrector 125 generates, based on the arrangement relationship (the shift amount between the shot region and the mold 8 with regard to the X-axis, the Y-axis, and the θZ-axis) detected by the detector 10, a correction signal for correcting the deviation signal.

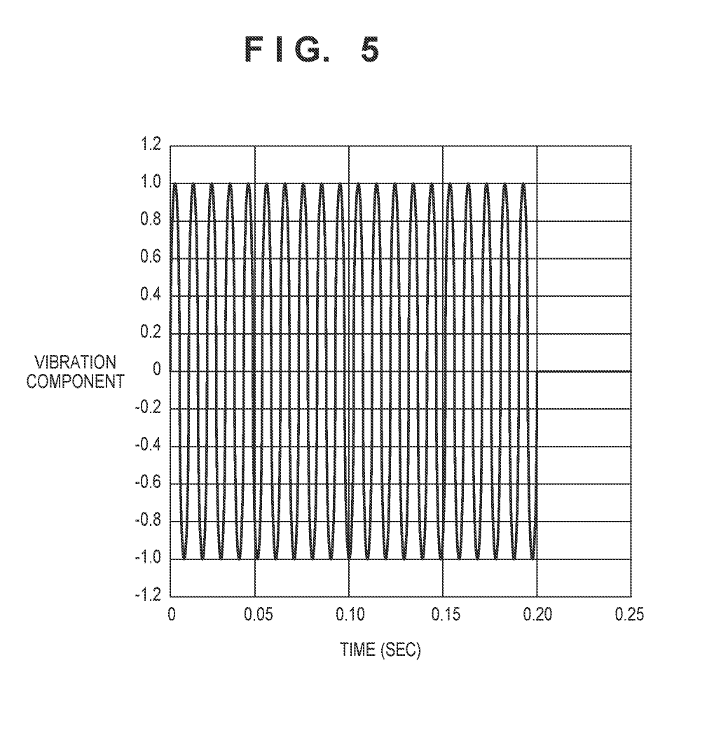

The adder 127 generates a corrected deviation signal (corrected error signal) by adding the deviation signal from the subtracter 126 and the correction signal from the corrector 125. Based on the corrected deviation signal from the adder 127, the compensator 123 generates a plurality of command values (for example, a command value with regard to the X-axis, a command value with regard to the Y-axis, and a command value with regard to the θZ-axis) to be supplied to a plurality of drivers of the driver group 124, respectively. The vibration component generator 122 generates a vibration component given to the imprint material IM in order to reduce the influence by the viscoelasticity of the imprint material IM between the substrate 3 and the mold 8. FIG. 5 exemplifies the vibration component generated by the vibration component generator 122 or the vibration component given to the imprint material. The vibration component generator 122 can superimpose, as a vibration component, a periodic signal on a driving signal given to the substrate driving mechanism 6 such that a vibration is applied to the imprint material IM between the substrate 3 and the mold 8. The controller 12 can stop superimposition of the periodic signal on the driving signal at a timing when the amplitude of the periodic signal becomes 0 while the arrangement relationship between the mold 8 and the shot region of the substrate 3 is adjusted. This makes it possible to stop application of the vibration to the imprint material IM in a state in which the vibration component is 0. The vibration component can have, for example, a frequency of 100 Hz (inclusive) to 1 kHz (exclusive), preferably a frequency of 300 Hz (inclusive) to 500 Hz (inclusive). The vibration component can have, for example, an amplitude of 20 nm (inclusive) to 150 nm (inclusive), and preferably an amplitude of 50 nm (inclusive) to 120 nm (inclusive).

The adder 128 outputs a command value by adding the vibration component from the vibration component generator 122 to at least one of the plurality of command values from the compensator 123. Note that a command value to which the vibration component from the vibration component generator 122 is not added out of the plurality of command values from the compensator 123 can be supplied from the compensator 123 to the driver group 124 directly.

The driver group 124 can include the plurality of drivers (for example, drivers with regard to the X-axis, the Y-axis, and the θZ-axis) corresponding to a plurality of actuators (for example, actuators with regard to the X-axis, the Y-axis, and the θZ-axis) of the substrate driving mechanism 6, respectively. The plurality of drivers output a plurality of driving signals (for example, currents) corresponding to the plurality of command values from the adder 128 and the compensator 123, respectively, to the plurality of actuators. Out of the plurality of actuators, an actuator driven by a driving signal corresponding to a command value on which a vibration component is superimposed (a driving signal on which a vibration component is superimposed) drives the substrate holder 4 (substrate 3) by a thrust force on which a vibration component is superimposed. This vibrates the imprint material IM between the substrate 3 and the mold 8, reducing the influence by the viscoelasticity of the imprint material IM between the substrate 3 and the mold 8. Out of the plurality of actuators, the actuator driven by the driving signal corresponding to the command value on which the vibration component is superimposed can be, for example, an actuator with regard to the X-axis or an actuator with regard to the Y-axis. Alternatively, out of the plurality of actuators, the actuator driven by the driving signal corresponding to the command value on which the vibration component is superimposed can be, for example, the actuator with regard to the X-axis, the actuator with regard to the Y-axis, or an actuator with regard to the θZ-axis.

Instead of the above arrangement, a vibration component may be superimposed on a driving signal supplied to the mold driving mechanism 9, and the mold driving mechanism 9 may apply a vibration to the imprint material IM.

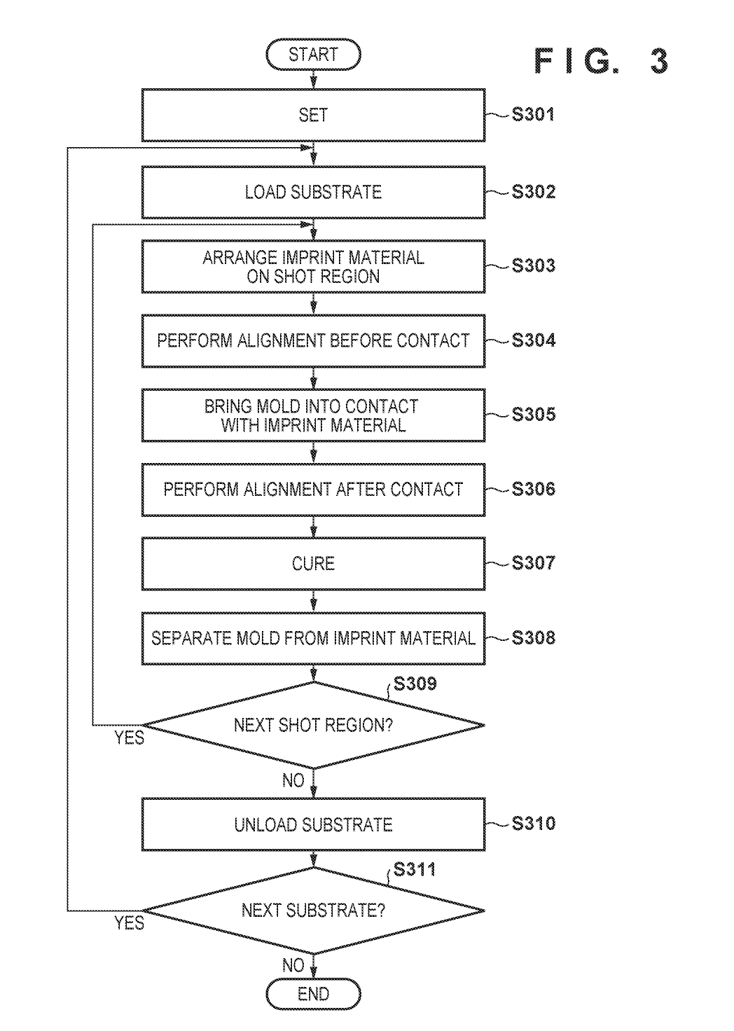

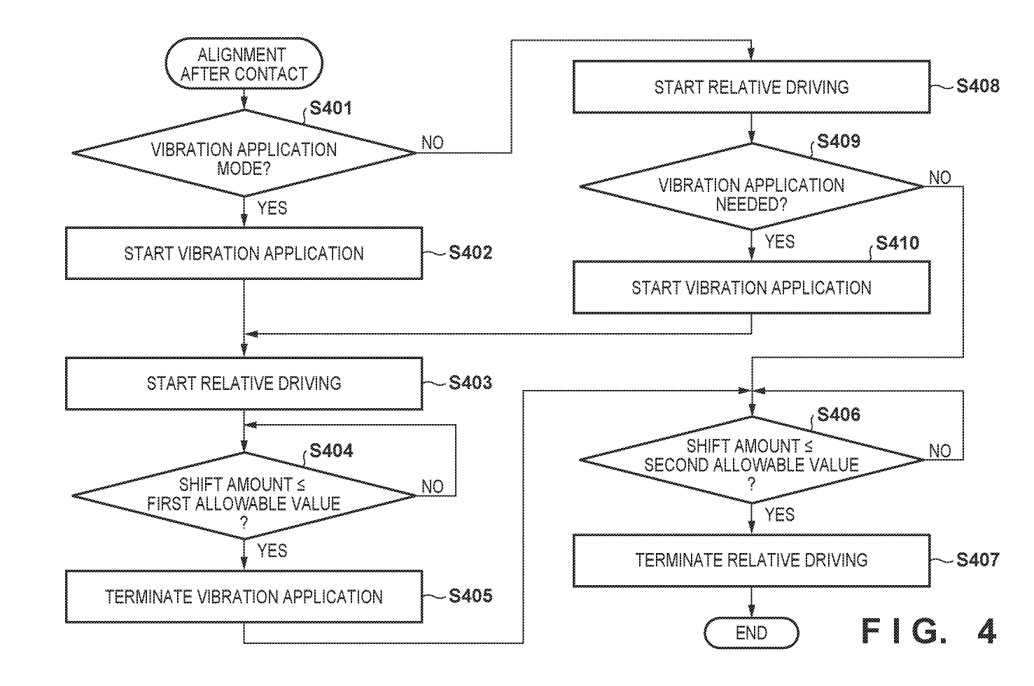

FIGS. 3 and 4 exemplify the operation of the imprint apparatus 100. This operation can be controlled by the controller 12 or the host main controller of the controller 12. Note that FIG. 3 shows the sequence of a process with respect to a lot formed by a plurality of substrates, and FIG. 4 shows the detailed sequence of step S306 in FIG. 3. First, in step S301, control parameter values for controlling the subsequent process are set. The control parameter values can include, for example, the first allowable value, the second allowable value, conditions for applying a vibration to the imprint material IM (for example, the amplitude and frequency of the vibration), and the like to be described below. In this embodiment, the imprint apparatus 100 or the adjuster 200 has a plurality of modes that include a vibration application mode (first mode) and a vibration non-application mode (second mode), and the control parameter values contain information for designating a mode.

The imprint apparatus 100 can include a database 13 that stores information indicating correspondence between the control parameter values and a plurality of conditions concerning an imprint process. The adjuster 200 or the controller 12 can decide a control parameter value for the substrate 3 to be processed with reference to the database 13 in accordance with conditions given for the imprint process to the substrate 3 to be processed. The control parameter value can be, for example, the first allowable value, the second allowable value, the amplitude and frequency of the vibration, or the like.

The conditions given for the imprint process to the substrate 3 to be processed can include, for example, the type of imprint material IM, the interval between the substrate 3 and the mold 8, the type of substrate 3, the type of mold 8, and the like. Note that the viscoelasticity of the imprint material IM can vary depending on the type of imprint material IM, and the interval between the substrate 3 and the mold 8. Alternatively, the viscoelasticity of the imprint material IM can also vary depending on the type (for example, the surface state) of substrate 3 and the type (for example, the pattern density) of mold 8. The adjuster 200 or the controller 12 can, for example, select conditions equal to the conditions given for the imprint process to the substrate 3 to be processed from among the plurality of conditions stored in the database 13 and decide control parameter values corresponding to the selected conditions.

In step S302, the substrate 3 is loaded onto the substrate holder 4. In step S303, the shot region of the substrate 3 is moved below the dispenser 7 by the substrate driving mechanism 6, and the imprint material IM is arranged on the shot region by the dispenser 7. In step S304, the shot region of the substrate 3 is moved below the mold 8 by the substrate driving mechanism 6 and aligned with the mold 8. In step S305, the adjuster 200 changes the arrangement relationship between the substrate 3 and the mold 8 so as to bring the mold 8 into contact with the imprint material IM on the shot region of the substrate 3. In step S305, for example, the mold driving mechanism 9 of the adjuster 200 drives the mold 8 downward, bringing the mold 8 into contact with the imprint material IM on the shot region of the substrate 3. At this time, the interval between the substrate 3 and the mold 8 can be controlled to, for example, about 1 μm. In such an interval, the imprint material IM shows viscoelasticity.

In step S306, in a state in which the mold 8 and the imprint material IM on the shot region of the substrate 3 are in contact with each other, the adjuster 200 (for example, the substrate driving mechanism 6) performs alignment between the shot region and the mold 8. Step S306 will be described later with reference to FIG. 4. In step S307, the curing device 11 supplies, to the imprint material IM, energy that cures it, thereby curing the imprint material IM. In step S308, the adjuster 200 changes the arrangement relationship between the substrate 3 and the mold 8 so as to separate the mold 8 from the cured imprint material IM. In step S308, for example, the mold driving mechanism 9 drives the mold 8 upward, separating the mold 8 from the cured imprint material IM.

In step S309, it is determined whether there is a shot region to undergo the imprint process next. If there is the shot region to undergo the imprint process next, the process returns to step S303 to execute steps S303 to S308 on the shot region. On the other hand, if the imprint process is performed on all shot regions to undergo the imprint process, the process advances to step S310. In step S310, the substrate 3 is unloaded from the substrate holder 4. In step S311, it is determined whether there is the substrate 3 to undergo the imprint process next. If there is the substrate 3 to undergo the imprint process next, the process returns to step S302 to execute steps S303 to S308 on the substrate 3. On the other hand, if the imprint process is performed on all the substrates 3 to undergo the imprint process, the process of the lot ends.

The process in step S306 of FIG. 3 will be described below with reference to FIG. 4. In step S401, the adjuster 200 or the controller 12 determines whether the mode set in step S301 is the vibration application mode (first mode) or the vibration non-application mode (second mode). Then, the process advances to step S402 if the vibration application mode is set, and the process advances to step S408 if the vibration non-application mode is set. The vibration application mode is a mode of adjusting the arrangement relationship between the substrate 3 and the mold 8 in a state in which a vibration is applied to the imprint material IM between the substrate 3 and the mold 8, and then further adjusting the arrangement relationship in a state in which the vibration is not applied to the imprint material between the substrate 3 and the mold 8. The vibration non-application mode is a mode of adjusting the arrangement relationship between the substrate 3 and the mold 8 in the state in which the vibration is not applied to the imprint material IM between the substrate 3 and the mold 8. In this embodiment, however, even when the vibration non-application mode is set, the vibration is applied if it is determined that the vibration needs to be applied.

In step S402, the adjuster 200 or the controller 12 starts applying the vibration to the imprint material IM. The vibration can be applied to the imprint material IM by causing the vibration component generator 122 to supply a vibration component to the adder 128. Application of the vibration to the imprint material IM reduces the influence by the viscoelasticity of the imprint material IM, facilitates relative driving of the substrate 3 and the mold 8, reduces a force acting on the mold 8 by the viscoelasticity, and reduces deformation in pattern of the mold 8.

In step S403, the adjuster 200 or the controller 12 starts adjustment of the arrangement relationship between the substrate 3 and the mold 8 by the adjuster 200 so as to perform alignment between the mold 8 and the shot region of the substrate 3 (so as to reduce the overlay error between the shot region and the mold 8). This adjustment is performed, while detecting the arrangement relationship between the shot region and the mold 8, for example, the shift amount between the shot region and the mold 8 with regard to the X-axis, the Y-axis, and the θZ-axis by the detector 10, so as to reduce this shift amount. Step S403 may be executed before step S402, but is preferably executed after step S402.

In step S404, the adjuster 200 or the controller 12 waits until the arrangement relationship (shift amount) between the mold 8 and the shot region of the substrate 3 falls within the first allowable value while determining, based on an output from the detector 10, whether the arrangement relationship (shift amount) falls within the first allowable value. Then, if the adjuster 200 or the controller 12 determines that the arrangement relationship (shift amount) falls within the first allowable value, the process advances to step S405 in which application of the vibration to the imprint material IM is terminated. Application of the vibration to the imprint material IM can be terminated by terminating supply of a vibration component from the vibration component generator 122 to the adder 128. The termination of supply of the vibration component from the vibration component generator 122 to the adder 128 includes setting the vibration component to 0. The first allowable value can be decided so as to make the influence by the viscoelasticity of the imprint material IM sufficiently small in adjustment of the arrangement relationship between the mold 8 and the shot region of the substrate 3 even after the termination of application of the vibration to the imprint material IM. If the relative driving amounts of the substrate 3 and the mold 8 are sufficiently small, it is possible to ignore the influence by the viscoelasticity of the imprint material IM.

In step S404, the adjuster 200 or the controller 12 may determine whether an elapsed time from the start of adjustment of the arrangement relationship between the substrate 3 and the mold 8 exceeds a reference time (control parameter value) in the state in which the vibration is applied to the imprint material IM between the substrate 3 and the mold 8. In this case, step S405 can be executed in accordance with the excess of the elapsed time over the reference time. The adjuster 200 or the controller 12 can decide a reference time for the substrate 3 to be processed with reference to the database 13 in accordance with the conditions given for the imprint process to the substrate 3 to be processed. The imprint apparatus 100 can include the database 13 that stores information indicating correspondence between a plurality of conditions concerning the imprint process and a plurality of control parameter values (a plurality of reference times).

In the following description, alignment between the mold 8 and the shot region of the substrate 3, that is, adjustment of the arrangement relationship between the substrate 3 and the mold 8 by the adjuster 200 is continued in the state in which the vibration is not applied to the imprint material IM. In step S406, the adjuster 200 or the controller 12 waits until the arrangement relationship (shift amount) between the mold 8 and the shot region of the substrate 3 falls within the second allowable value while determining, based on an output from the detector 10, whether the arrangement relationship (shift amount) falls within the second allowable value. Then, if the adjuster 200 or the controller 12 determines that the arrangement relationship (shift amount) falls within the second allowable value, the process advances to step S407 in which adjustment of the arrangement relationship between the substrate 3 and the mold 8 is terminated. Note that the second allowable value is a value stricter than the first allowable value. For example, when the first allowable value and the second allowable value are given as shift amounts (alignment errors), the second allowable value is a value smaller than the first allowable value.

Unlike the above, if application of the vibration to the imprint material IM is stopped after the termination of adjustment of the arrangement relationship between the substrate 3 and the mold 8, the arrangement relationship between the substrate 3 and the mold 8 can be changed by applying the vibration to the imprint material IM. This may decrease the alignment accuracy (overlay accuracy) between the mold 8 and the shot region of the substrate 3. Even if application of the vibration to the imprint material IM is stopped simultaneously with the termination of adjustment of the arrangement relationship between the substrate 3 and the mold 8, the influence of the vibration can remain as an alignment error due to the inertia of the substrate holder 4 and mold driving mechanism 9, the viscoelasticity of the imprint material IM, and the like.

A case in which it is determined in step S401 that the vibration non-application mode is set will be described below. In step S408, the adjuster 200 or the controller 12 starts adjustment of the arrangement relationship between the substrate 3 and the mold 8 by the adjuster 200 so as to perform alignment between the mold 8 and the shot region of the substrate 3 (so as to reduce the overlay error between the shot region and the mold 8). This adjustment is performed, while detecting the arrangement relationship between the shot region and the mold 8, for example, the shift amount between the shot region and the mold 8 with regard to the X-axis, the Y-axis, and the θZ-axis by the detector 10, so as to reduce this shift amount.

In the vibration non-application mode, step S408 is executed in the state in which the vibration is not applied to the imprint material IM. However, in a case in which, for example, the relative driving amounts of the substrate 3 and the mold 8 become larger than assumed amounts, a vibration may need to be applied to the imprint material IM. Therefore, in step S409, the adjuster 200 or the controller 12 determines whether the vibration needs to be applied to the imprint material IM while the vibration non-application mode is performed. The adjuster 200 or the controller 12 can determine that the vibration needs to be applied to the imprint material IM, for example, if a load for adjusting the arrangement relationship between the substrate 3 and the mold 8 (for example, a force needed by the substrate driving mechanism 6 to drive the substrate holder 4) exceeds a threshold. More specifically, the adjuster 200 or the controller 12 can determine that the vibration needs to be applied to the imprint material IM if the arrangement relationship (shift amount) detected by the detector 10 exceeds the threshold. If the adjuster 200 or the controller 12 determines in step S409 that the vibration needs to be applied to the imprint material IM, it starts applying the vibration to the imprint material IM in step S410. This means terminating the vibration non-application mode and shifting to the vibration application mode. A specification such as the frequency and/or amplitude of the vibration may be decided in accordance with the load for adjusting the arrangement relationship between the substrate 3 and the mold 8, for example, the arrangement relationship (shift amount) detected by the detector 10. Alternatively, the specification such as the frequency and/or amplitude of the vibration may follow contents set in step S301. If the adjuster 200 or the controller 12 determines in step S409 that the vibration need not be applied to the imprint material IM, the process advances to step S406.

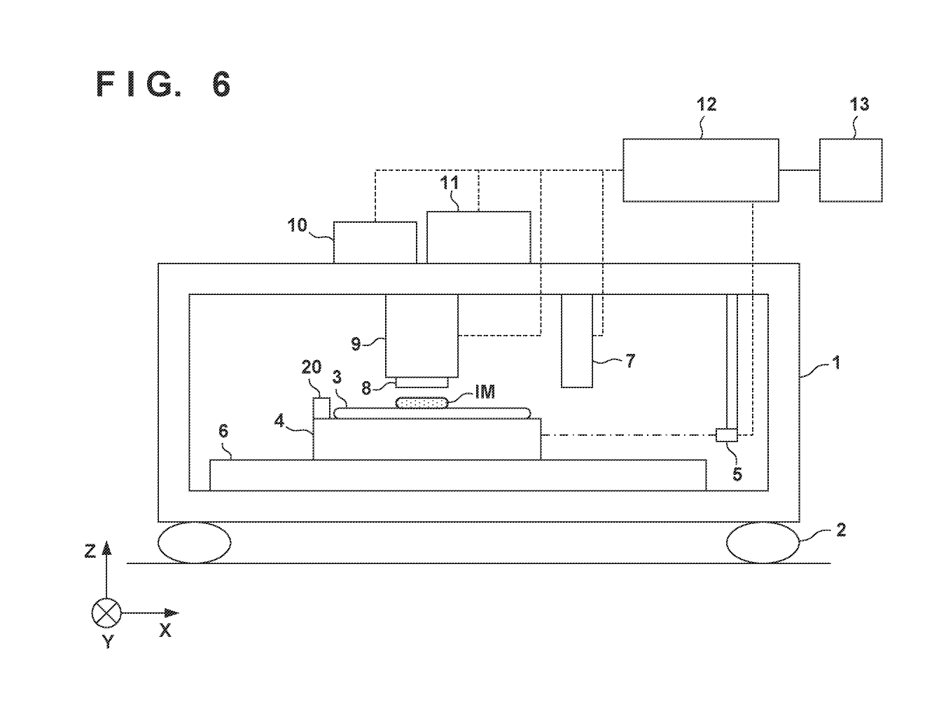

In the above embodiment, the vibration component is superimposed on the command value or the driving signal for operating the substrate driving mechanism 6 or the mold driving mechanism 9. As exemplified in FIG. 6, however, a vibration generator 20 may be provided on a substrate holder 4. The vibration generator 20 can apply a vibration to an imprint material IM between a substrate 3 and a mold 8. A driving vibration corresponding to the vibration component exemplified in FIG. 4 or a signal for instructing occurrence of a vibration may be given from an adjuster 200 or a controller 12 to the vibration generator 20. The vibration generator 20 may be provided on a mold driving mechanism 9.

A pattern of a cured product formed by using an imprint apparatus is used permanently for at least some of various articles or used temporarily when the various articles are manufactured. The article includes an electric circuit element, an optical element, a MEMS, a printing element, a sensor, a mold, or the like. The electric circuit element includes, for example, a volatile or nonvolatile semiconductor memory such as a DRAM, an SRAM, a flash memory, or an MRAM or a semiconductor element such as an LSI, a CCD, an image sensor, or an FPGA. The mold includes, for example, an imprinting mold.

The pattern of the cured product is used without any change as a constituent member of at least a part of the above-described article or used temporarily as a resist mask. The resist mask is removed after etching, ion implantation, or the like is performed in a processing step of the substrate.

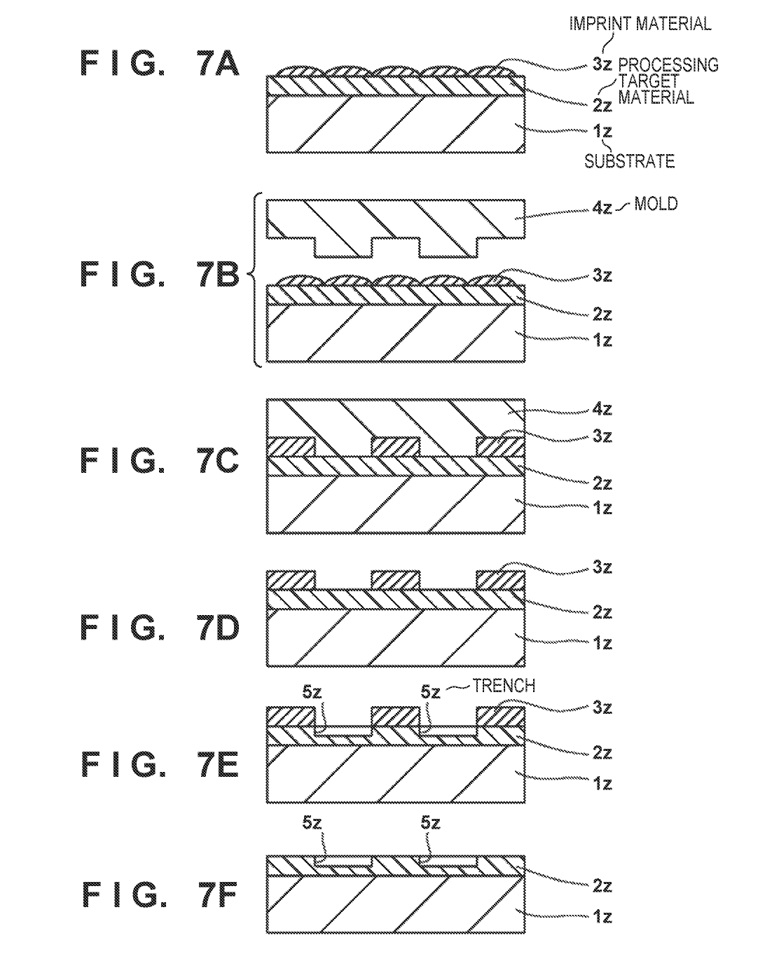

An article manufacturing method of forming a pattern on a substrate by an imprint apparatus, processing the substrate on which the pattern has been formed, and manufacturing an article from the substrate on which the process has been performed will be described next. As shown in FIG. 7A, a substrate 1z such as a silicon wafer having a processing target material 2z such as an insulator formed on its surface is prepared, and then an imprint material 3z is applied on the surface of the processing target material 2z by an inkjet method or the like. A state is shown here in which the imprint material 3z formed into a plurality of droplets is applied on the substrate.

As shown in FIG. 7B, a side of an imprinting mold 4z on which its three-dimensional pattern is formed faces the imprint material 3z on the substrate. As shown in FIG. 7C, a mold 4z and the substrate 1z to which the imprint material 3z is applied are brought into contact with each other, and a pressure is applied. The imprint material 3z fills the gap between the mold 4z and the processing target material 2z. The imprint material 3z is cured by irradiating it with light as curing energy through the mold 4z in this state.

As shown in FIG. 7D, the pattern of the cured product of the imprint material 3z is formed on the substrate 1z by releasing the mold 4z and the substrate 1z from each other after curing the imprint material 3z. The pattern of this cured product has a shape such that the concave portion of the mold corresponds to the convex portion of the cured product, and the convex portion of the mold corresponds to the concave portion of the cured product. That is, the three-dimensional pattern of the mold 4z is transferred to the imprint material 3z.

As shown in FIG. 7E, out of the surface of the processing target material 2z, portions without any cured product or portions where the cured products remain thin are removed and become trenches 5z by performing etching using the pattern of the cured product as an etching resistant mask. As shown in FIG. 7F, an article having the trenches 5z formed in the surface of the processing target material 2z can be obtained by removing the pattern of the cured product. The pattern of the cured product is removed here. However, the pattern of the cured product may be used as, for example, an interlayer dielectric film included in the semiconductor element or the like, that is, the constituent member of the article without removing it after processing.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-092565, filed May 8, 2017, which is hereby incorporated by reference herein in its entirety.

What is claimed is:

1. An imprint apparatus that performs an imprint process of forming a pattern on a substrate by bringing a mold into contact with an imprint material on the substrate and curing the imprint material, the apparatus comprising:
a detector configured to detect an arrangement relationship between the substrate and the mold; and
an adjuster configured to adjust the arrangement relationship based on an output from the detector,
wherein the adjuster adjusts the arrangement relationship in a state in which a vibration is applied to an imprint material between the substrate and the mold, and then further adjusts the arrangement relationship in a state in which the vibration is not applied to the imprint material between the substrate and the mold.

2. The apparatus according to claim 1, wherein the adjuster stops the vibration applied to the imprint material between the substrate and the mold if it is determined, based on the output from the detector, that the arrangement relationship falls within a first allowable value, and then terminates adjustment of the arrangement relationship if it is determined, based on the output from the detector, that the arrangement relationship falls within a second allowable value stricter than the first allowable value.

3. The apparatus according to claim 2, further comprising a database configured to store information indicating correspondence between a plurality of conditions concerning the imprint process and a plurality of first allowable values,
wherein the adjuster decides the first allowable value for a substrate to be processed with reference to the database in accordance with a condition given for the imprint process to the substrate to be processed.

4. The apparatus according to claim 1, wherein the adjuster stops the vibration applied to the imprint material between the substrate and the mold in accordance with an excess of an elapsed time from a start of adjustment of the arrangement relationship over a reference time in the state in which the vibration is applied to the imprint material between the substrate and the mold.

5. The apparatus according to claim 4, further comprising a database configured to store information indicating correspondence between a plurality of conditions concerning the imprint process and a plurality of reference times,
wherein the adjuster decides a reference time for a substrate to be processed with reference to the database in accordance with a condition given for the imprint process to the substrate to be processed.

6. The apparatus according to claim 1, wherein the adjuster includes a driving mechanism configured to change the arrangement relationship, and a controller configured to apply a vibration to the imprint material between the substrate and the mold by controlling the driving mechanism so as to vibrate the arrangement relationship.

7. The apparatus according to claim 6, wherein the controller superimposes a periodic signal on a driving signal given to the driving mechanism such that a vibration is applied to the imprint material between the substrate and the mold, and
the controller stops superimposition of the periodic signal on the driving signal at a timing when an amplitude of the periodic signal becomes 0 while adjusting the arrangement relationship.

8. The apparatus according to claim 1, wherein the adjuster includes a driving mechanism configured to change the arrangement relationship, a substrate holder configured to hold the substrate, and a vibration generator provided on the substrate holder, and the vibration generator applies a vibration to the imprint material between the substrate and the mold.

9. The apparatus according to claim 1, wherein the adjuster includes a driving mechanism configured to change the arrangement relationship, a mold driving mechanism configured to drive the mold, and a vibration generator provided on the mold driving mechanism, and the vibration generator applies a vibration to the imprint material between the substrate and the mold.

10. The apparatus according to claim 1, wherein the adjuster has a first mode and a second mode,
the first mode is a mode of adjusting the arrangement relationship in the state in which the vibration is applied to the imprint material between the substrate and the mold, and then further adjusting the arrangement relationship in the state in which the vibration is not applied to the imprint material between the substrate and the mold,
the second mode is a mode of adjusting the arrangement relationship in the state in which the vibration is not applied to the imprint material between the substrate and the mold, and
the adjuster shifts from the second mode to the first mode if a load for adjusting the arrangement relationship exceeds a threshold while performing the second mode and in the first mode, adjusts the arrangement relationship in the state in which the vibration is applied to the imprint material between the substrate and the mold, and then further adjusts the arrangement relationship in the state in which the vibration is not applied to the imprint material between the substrate and the mold.

11. An article manufacturing method comprising:
forming a pattern on a substrate by an imprint apparatus defined in claim 1; and
processing the substrate on which the pattern has been formed in the forming.
